(19) United States
(12) Patent Application Publication
(10) Pub. No.: US 2016/0236307 A1
(43) Pub. Date: Aug. 18, 2016

(54) ROTARY CUTTING TOOL BLANKS AND APPLICATIONS THEREOF

(71) Applicant: Kennametal Inc., Latrobe, PA (US)

(72) Inventors: Herbert Rudolf KAUPER, Erlangen (DE); Julia Tempelmeier, Roth (DE); Stephen Michael George, Greensboro, NC (US)

(21) Appl. No.: 14/623,213

(22) Filed: Feb. 16, 2015

(51) Int. Cl. B23P 15/32; B23B 51/00; B23P 15/34

(52) U.S. Cl. CPC B23P 15/32; B23P 15/34; B23B 51/00; B23B 2222/92; B23B 2250/12

(57) ABSTRACT

In one aspect, blanks for rotary tooling applications are described herein. Such blanks can employ architectures realizing material efficiencies and temporal efficiencies when processed into rotary cutting tools. For example, a rotary cutting tool blank described herein comprises a plurality of interior channels extending along a longitudinal axis of the blank, the interior channels having radial positioning for external exposure along an axial length of cut of the rotary cutting tool upon introduction flutes to the blank.

### FIELD

The present invention relates to tool blanks and, in particular, to blanks for rotary tooling applications.

### BACKGROUND

Tungsten is an industrially significant metal finding application in a variety of fields with particular emphasis in the tooling industry. The high hardness, heat resistance and wear resistance of tungsten and its carbide make it an ideal candidate for use in cutting tools, mining and civil engineering tools and forming tools, such as molds and punches. Cemented tungsten carbide tools, for example, account for the majority of worldwide tungsten consumption. According a 2007 United States Geological Survey, mineral deposits of tungsten resources totaled in the neighborhood of nearly 3 million tons. At current production levels, these resources will face exhaustion within the next forty years. Moreover, a handful of nations control the majority of worldwide tungsten deposits. China, for example, controls approximately 62% of tungsten deposits and accounts for 85% of ore production volume. In view of this inequitable global distribution and associated exhaustion projections, new tooling architectures are required that emphasize efficient use of tungsten, tungsten carbide and other industrially significant materials. For example, tool architectures may be desired that permit construction of a tool with reduced tungsten, tungsten carbide and/or other industrially significant materials.

### SUMMARY

In one aspect, blanks for rotary tooling applications are described herein. Such blanks can employ architectures realizing material efficiencies and temporal efficiencies when processed into rotary cutting tools. For example, a rotary cutting tool blank described herein comprises a plurality of interior channels extending along a longitudinal axis of the blank, the interior channels having radial positioning for external exposure along an axial length of cut of the rotary cutting tool upon introduction of flutes to the blank. In having such radial positioning, the interior channels do not interfere with interior fluid transport channels that may also extend along the longitudinal axis of the blank.

In another aspect, methods of fabricating rotary cutting tools are described herein. In some embodiments, a method of fabricating a rotary cutting tool comprises providing a blank including a plurality interior channels extending along a longitudinal axis of the blank and mechanically working the blank to externally expose the interior channels along an axial length of cut of the rotary cutting tool during flute formation. In some embodiments, the blank and associated interior channels are provided by extruding a grade powder composition. Further, radial positioning of the interior channels does not interfere with interior fluid transport channels that also may be provided in the extrusion process.

### BRIEF DESCRIPTION OF THE DRAWINGS

FIG. 1 illustrates a cross-sectional view of a blank according to one embodiment described herein.

FIG. 2 illustrates a perspective view of a blank according to the embodiment of FIG. 1.

### DETAILED DESCRIPTION

Embodiments described herein can be understood more readily by reference to the following detailed description and examples and their previous and following descriptions. Elements and apparatus described herein, however, are not limited to the specific embodiments presented in the detailed description. It should be recognized that these embodiments are merely illustrative of the principles of the present invention. Numerous modifications and adaptations will be readily apparent to those of skill in the art without departing from the spirit and scope of the invention.

### I. Blanks for Rotary Cutting Tools

As described herein, a blank for a rotary cutting tool comprises a plurality of interior channels extending along a longitudinal axis of the blank, the interior channels having radial positioning for external exposure along an axial length of cut of the rotary cutting tool upon introduction of flutes to the blank.

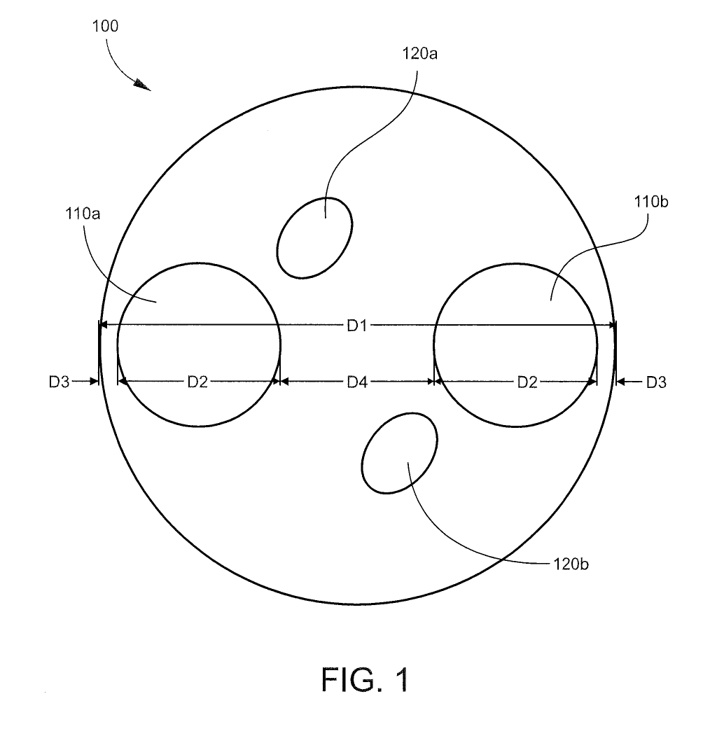

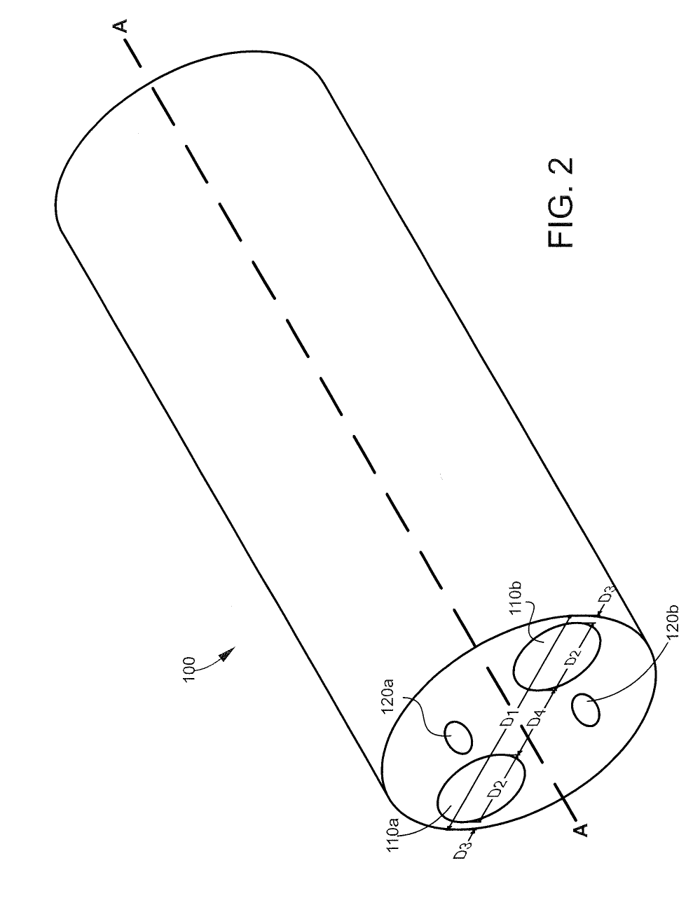

Referring now to FIGS. 1 and 2, there is illustrated a blank for a rotary cutting tool, generally designated as reference number 100, in accordance with one embodiment described herein. As illustrated in FIGS. 1 and 2, the blank (100) comprises interior channels (110a, 110b) extending along longitudinal axis (A-A) and arranged at radial positions for external exposure along an axial length of cut upon introduction of flutes to the blank (100). In the embodiment of FIGS. 1 and 2, the blank (100) comprises two interior channels (110a, 110b) for exposure during flute formation. However, any number of interior channels for exposure are possible depending on design of the rotary cutting tool formed from the blank. For example, the blank can include three interior channels for triple-fluted cutting tools or four interior channels for a cutting tool employing four flutes.

Interior channels can have any cross-sectional shape not inconsistent with the objectives of the present invention. For example, interior channels (110a, 110b) can have a circular cross-sectional shape, as illustrated in FIG. 1, or can be elliptical, trigonal, square, rectangular or higher polygonal. Further, interior channels can extend along the longitudinal axis in a helical manner. Alternatively, the interior channels extend along the longitudinal axis in a linear or substantially linear manner. For example, the interior channels can extend parallel to the longitudinal axis.

Interior channels (110a, 110b) of the blank (100) can have any dimensions or be arranged in any manner not inconsistent with exposure upon flute formation. In FIG. 1, D1 represents diameter of the blank (100), and D2 represents width of the interior channels (110a, 110b). Interior channel width can be selected according to several considerations, including flute design and flute dimensions of the rotary cutting tool formed from the blank. For example, the interior channels can be incorporated into the flute architecture when exposed during the fluting process. Alternatively, the interior channels can be precursor structures from which the flutes are further ground.

Interior channels can have any width (D2) relative to the diameter (D1) of the blank not inconsistent with the objectives of the present invention. For example, a value of the width (D2) can be selected from Table I.

TABLE I
width D2 (% of D1)
20-45
20-43
20-35
20-30
30-43
30-49

In addition, interior channels (110a, 110b) can be spaced apart from one another at any distance (D4) relative to the diameter (D1). Spacing of interior channels can be selected according to several considerations including flute design and flute dimensions as well as the positioning and dimensions of any interior fluid transport channels. A value of the distance (D4) between interior channels (110a, 110b) can be selected, for example, from Table II.

TABLE II
distance D4 (% of D1)
10-40
10-30
10-20
20-40
30-40

Further, the interior channels can be spaced from the circumferential surface of the blank at any distance not inconsistent with the objectives of the present invention. Spacing from the blank circumference can be selected according to several considerations including dimension of the interior channels, positioning and dimensions of any interior fluid transport channels and minimization of material removal during flute grinding. In some embodiments, a distance (D3) from the blank circumferential surface is selected form Table III.

TABLE III
distance D3 (% of D1)
5-20
10-20
15-20
5-15
5-10

As described herein, the interior channels are exposed along an axial length of cut of the rotary cutting tool during flute formation. In embodiments, the interior channels extend into a shank portion of the blank where they are not exposed during processing the blank into the rotary cutting tool. In such embodiments, the interior channels can be filled with one or more materials. Suitable filler materials can include plastic, fluid metal, paste and/or other filler materials that do not compromise the integrity and performance of the rotary cutting tool formed form the blank.

Alternatively, blanks described herein correspond only to the cutting portion of a rotary cutting tool. In such embodiments, the interior channels can be exposed along the entire length or substantially the entire length of the blank. The processed blank can then be coupled to a shank portion to complete fabrication of the rotary cutting tool.

Rotary cutting tool blanks described herein can further comprise at least one interior fluid transport channel. Importantly, the interior channels exposed during flute formation do not interfere with interior fluid transport channels. The embodiment illustrated in FIGS. 1 and 2 comprises two fluid transport channels (120a, 120b), however any number of fluid transport channels can be used. A fluid transport channel (120a, 120b) can have any desired cross-sectional shape or diameter. For example, FIG. 1 illustrates fluid transport channels (120a, 120b) having an oblate cross-sectional shape, but other shapes, such as circular, triangular, square, rectangular or higher polygonal can be used. Further, fluid transport channels (120a, 120b) can be larger or smaller than internal channels (110a, 110b). Fluid transport channels (120a, 120b) are generally positioned radially such that grinding of the blank (100) does not expose the channels (120a, 120b). For example, in embodiments comprising a single fluid transport channel, the channel can be located at a centermost point within the blank. Fluid transport channels (120a, 120b) also extend along the longitudinal axis (A-A) of the blank (100). In some embodiments, one or more fluid transport channels extend helically along the longitudinal axis. Alternatively, one or more fluid transport channels extend linearly or substantially linearly along the longitudinal axis. In such embodiments, the one or more fluid transport channels can be parallel to the longitudinal axis.

In some embodiments, the rotary cutting tool blank is formed of sintered cemented carbide. Sintered cemented carbide can include any metal carbide and metallic binder providing desired properties to the rotary cutting tool fabricated from the blank including, but not limited to, hardness, fracture toughness, wear resistance and resistance to thermal fatigue. Sintered cemented carbide, in some embodiments, employs a tungsten carbide (WC) hard particle phase in an amount of at least about 85 weight percent. In some embodiments, WC is present in an amount of at least about 94 weight percent. The hard particle phase can further comprise carbide, nitride and/or carbonitride of one or more metals selected from Group IVB, VB and/or VIB of the Periodic Table. In some embodiments, for example, the hard particle phase comprises at least one of tantalum carbide, niobium carbide, vanadium carbide, chromium carbide, zirconium carbide, hafnium carbide and titanium carbide and solid solutions thereof. The hard particle phase can also exhibit a fine grain size for enhancing hardness. Generally, hard particles of the sintered cemented carbide have an average grain size less than 10 μm. In some embodiments, hard particles of the sintered cemented carbide have an average grain size of 0.5-5 μm or 1-3 μm.

Further, the metallic binder phase can comprise at least one of cobalt, nickel and iron. In some embodiments, for example, cobalt metallic binder is present in the sintered carbide in an amount of 5-12 weight percent or 6-10 weight percent. Weight percent of the hard particle phase and metallic binder phase can be adjusted to provide suitable hardness and/or toughness for cutting applications. Grain size of the hard particle phase can also be adjusted according to hardness and/or other performance requirements.

Alternatively, the rotary cutting tool blank can formed of ceramic. Suitable ceramic materials can include silicon nitride, silicon aluminum oxynitride (SiAlON), silicon carbide, silicon carbide whisker containing alumina or mixtures thereof. In some embodiments, for example, ceramic powder of desired composition is sintered to form the rotary cutting tool blank. In further embodiments, the rotary cutting tool blank can be formed of other alloys such as steels, including high speed tool steel (HSS) or a cermet. For example, powder steel alloy of desired composition can be sintered to form the rotary cutting toll blank.

### II. Methods of Fabricating Rotary Cutting Tools

In another aspect, methods of fabricating rotary cutting tools are described herein. In some embodiments, a method of fabricating a rotary cutting tool comprises providing a blank including a plurality of interior channels extending along a longitudinal axis of the blank and working the blank to externally expose the interior channels along an axial length of cut of the rotary cutting tool during flute formation.

The blank is initially provided green form by extruding, molding and/or pressing a grade powder composition. Suitable grade powders can include any metal carbide and metallic binder providing desired properties of the rotary cutting tool fabricated from the blank including, but not limited to, hardness, fracture toughness, wear resistance and resistance to thermal fatigue. For example, in some embodiments, grade powder comprises a hard particle phase comprising WC and powder metallic binder of at least one of cobalt, nickel and iron. The hard particle phase can further comprise carbide, nitride and/or carbonitride of one or more metals selected from Group IVB, VB and/or VIB of the Periodic Table. In some embodiments, for example, the hard particle phase comprises at least one of tantalum carbide, niobium carbide, vanadium carbide, chromium carbide, zirconium carbide, hafnium carbide and titanium carbide and solid solutions thereof. The hard particle phase can also exhibit a fine grain size for enhancing hardness. Generally, hard particles of the grade powder have an average grain size less than 10 μm. In some embodiments, hard particles of the sintered cemented carbide have an average grain size of 0.5-5 μm or 1-3 μm.

Alternatively, the grade powder can employ ceramic materials including, but not limited to, silicon nitride, SiAlON, silicon carbide, silicon carbide whisker containing alumina or mixtures thereof. In further embodiments, powder alloy is extruded, molded and/or pressed to provide the green blank. For example, powder steel compositions, such as HSS, can be extruded, molded and/or pressed for blank formation.

The blank can have structural properties described in Section I hereinabove. Extrusion, molding and/or pressing processes can impart the interior channels at radial positions for exposure during flute grinding. The extrusion, molding and/or pressing process can also provide interior fluid transport channels which are not exposed during blank processing into a rotary cutting tool.

In some embodiments, the green blank is fully sintered prior to working to expose the interior channels along an axial length of cut of the rotary cutting tool formed from the blank. The green blank can be vacuum sintered or sintered under a hydrogen atmosphere. During vacuum sintering, the green part is placed in a vacuum furnace and sintered at temperatures of 1400° C. to 1500° C. In some embodiments, hot isostatic pressing (HIP) is added to the vacuum sintering process. Hot isostatic pressing can be administered as a post-sinter operation or during the vacuum sintering yielding a sinter-HIP process. The resulting sintered blank can be fully dense or substantially fully dense. Alternatively, the green blank can be brown sintered or pre-sintered prior to working. In further embodiments, the blank can be worked in green form to expose the interior channels along an axial length of cut.

The green, brown-sintered or fully sintered blank can be worked by one or more techniques to externally expose the interior channels along an axial length of cut of the rotary cutting tool during flute formation. For example, in some embodiments, the blank is ground to provide the flutes and expose the interior channels. As described herein, the presence of the interior channels facilitates flute formation by reducing the volume of material removed and concomitantly, the time required to remove such material. Therefore, blanks described herein permit material conservation while reducing processing time to convert the blank into a rotary cutting tool. Rotary cutting tools formed from blanks described herein include, but are not limited to, drills and endmills of any desired configuration.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A blank for a rotary cutting tool comprising:
a plurality of interior channels extending along a longitudinal axis of the blank, the interior channels having radial positioning for external exposure along an axial length of cut of the rotary cutting tool upon introduction of flutes to the blank.

2. The blank of claim 1, wherein at least one of the interior channels has a width of 0.2 (d) to 0.45 (d), wherein d is diameter of the blank.

3. The blank of claim 1, wherein at least one of the interior channels has a width of 0.3 (d) to 0.43 (d), wherein d is diameter of the blank.

4. The blank of claim 1, wherein the interior channels extend along the longitudinal axis in a helical manner.

5. The blank of claim 1, wherein the interior channels extend linearly along the longitudinal axis.

6. The blank of claim 1, wherein the at least one of the interior channels is spaced from a circumferential surface of the blank a distance of 0.05 (d) to 0.2 (d), wherein d is diameter of the blank.

7. The blank of claim 6, wherein the interior channels are spaced from one another a distance of 0.1 (d) to 0.4 (d), wherein d is diameter of the blank.

8. The blank of claim 1, further comprising one or more interior fluid transport channels extending along the longitudinal axis of the blank.

9. The blank of claim 1, wherein the blank is formed of at least one of sintered cemented carbide, ceramic and alloy.

10. The blank of claim 1, having a shank portion and a cutting portion extending from the shank portion.

11. The blank of claim 1 having at least three interior channels.

12. A method of fabricating a rotary cutting tool comprising:
providing a blank including a plurality of interior channels extending along a longitudinal axis of the blank; and
working the blank to externally expose the interior channels along an axial length of cut of the rotary cutting tool during flute formation.

13. The method of claim 12, wherein providing the blank comprises at least one of extruding, molding and pressing a grade powder composition.

14. The method of claim 13, wherein the grade powder composition comprises a hard particle phase and a metallic binder phase.

15. The method of claim 13, wherein the grade powder is a ceramic grade powder.

16. The method of claim 13, wherein the blank is sintered prior to working the blank to externally expose the interior channels.

17. The method of claim 12, wherein the blank further comprises one or more interior fluid transport channels that are not externally exposed from working the blank.

18. The method of claim 12, wherein at least one of the interior channels has a width of 0.2 (d) to 0.45 (d), wherein d is diameter of the blank.

19. The method of claim 12, wherein the at least one of the interior channels is spaced from a circumferential surface of the blank a distance of 0.05 (d) to 0.2 (d), wherein d is diameter of the blank.

20. The method of claim 19, wherein the interior channels are spaced from one another a distance of 0.1 (d) to 0.4 (d), wherein d is diameter of the blank.
